(19) United States
(12) Patent Application Publication
(10) Pub. No.: US 2011/0018384 A1
(43) Pub. Date: Jan. 27, 2011

(54) MOTOR

(75) Inventors: Takashi Kenjo, Kyoto (JP); Nakaba Kataoka, Kyoto (JP); Yoshihiro Uchitani, Kyoto (JP); Yoshiaki Yamashita, Kyoto (JP)

Correspondence Address: NIDEC CORPORATION;c/o KEATING & BENNETT, LLP, 1800 Alexander Bell Drive, SUITE 200, Reston, VA, 20191, US

(73) Assignee: NIDEC CORPORATION, Kyoto (JP)

(21) Appl. No.: 12/934,295

(22) PCT Filed: Mar. 26, 2009
(86) PCT No.: PCT/JP2009/056108

§ 371 Date: Sep. 24, 2010

(30) Foreign Application Priority Data
Mar. 26, 2008 (JP) 2008-081188

(51) Int. Cl. H02K 1/16

(52) U.S. Cl. 310/216.092

(57) ABSTRACT

In a motor, a raised portion arranged to project toward a rotor magnet is provided on an opposed surface of each tooth portion. This raised portion provided on an opposed surface of each tooth portion. This raised portion is provided at a substantial middle of the opposed surface in a circumferential direction. This allows a waveform of a cogging torque generated by the raised portions and a fundamental of a waveform of a cogging torque generated by slot openings to be substantially in opposite phases. Cogging torque generated by the slot openings can be thereby reduced, because of the cogging torque generated by the raised portion.

### FIELD OF THE INVENTION

The present invention relates to a motor.

### DESCRIPTION OF THE RELATED ART

Development of electric power steering apparatuses in which a motor, instead of hydraulic pressure, is used as a driving source to provide assistance in operating a steering wheel has been advancing in recent years. Replacement of a hydraulic power steering apparatus with such an electric power steering apparatus leads to a several percent improvement in a fuel consumption of a vehicle.

The electric power steering apparatus is also required to prevent a vibration of the motor from being transmitted to the steering wheel so that an operator of the steering wheel may not feel uncomfortable. Accordingly, a variety of motors designed to reduce a cogging torque, which is one source of the vibration of the motor, have been developed (for example, JP-A 2003-61272).

Vehicles today, which are becoming more and more electronic, have a greater number of electronic components installed therein than in older vehicles. Moreover, with an increasing size of a space required for passengers, the size of a space for the electronic components has been decreasing. As a result, there has been an increased demand for a size reduction of each electronic component in a vehicle. Along with this demand, there has been an increased demand for a size reduction of the motor which serves as the driving source of the electric power steering apparatus.

JP-A 2003-61272 discloses a technique of employing supplemental grooves as pseudo-slots to increase the total number of occurrences of a cogging torque in a rotation of a rotating body to thereby reduce the respective strength of each individual occurrence of cogging torque. However, in this case, a reduction of the cogging torque cannot be achieved unless a pulsation of permeance due to the supplemental grooves is equivalent to a pulsation of permeance due to slots (i.e., slots used for windings). Therefore, each supplemental groove needs to have a large size and depth. This large size and depth results in a considerable reduction in an electromotive force that is generated in accordance with the rotation of the rotating body, and a reduction in a rotational torque of the motor.

### SUMMARY OF THE INVENTION

Motors according to preferred embodiments of the present invention achieve a reduction in a cogging torque while at the same time limiting a reduction in a rotational torque.

For example, a motor according to a preferred embodiment of the present invention includes a permanent magnet having M magnetic poles (M is a non-negative integer), and an armature having N tooth portions (N is a non-negative integer). Each tooth portion includes an opposed surface arranged opposite the permanent magnet, the opposed surface including a raised portion or portions arranged to project toward the permanent magnet. Every two tooth portions adjacent to each other include a slot opening defined therebetween, the slot opening being arranged to open toward the permanent magnet. A circumferential position of each raised portion is arranged such that a waveform of a cogging torque generated by the raised portions and a fundamental of a waveform of a cogging torque generated by the slot openings are provided in substantially opposite phases.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic cross-sectional view of a motor according to a first preferred embodiment of the present invention.

FIG. 2 is a schematic cross-sectional view of an armature according to the first preferred embodiment of the present invention.

FIG. 3 is a schematic enlarged view of a portion of an armature core according to the first preferred embodiment of the present invention.

FIG. 4 is a schematic enlarged view of a portion of the armature core illustrated in FIG. 3.

FIG. 5 is a graph showing a relationship between an angle and cogging torques.

FIG. 6 is a schematic enlarged view of a portion of an armature core according to a second preferred embodiment of the present invention.

FIG. 7 is a schematic enlarged view of a portion of the armature core illustrated in FIG. 6.

FIG. 8 is a schematic enlarged view of a portion of an armature core according to a third preferred embodiment of the present invention.

FIG. 9 is a schematic enlarged view of a portion of the armature core illustrated in FIG. 8.

FIG. 10 is a schematic perspective view of a portion of an armature core according to a fourth preferred embodiment of the present invention.

FIG. 11 is a schematic perspective view of a portion of an armature core according to an example modification of the fourth preferred embodiment of the present invention.

FIG. 12 is a schematic perspective view of a portion of an armature core according to another example modification of the fourth preferred embodiment of the present invention.

FIG. 13 is a chart illustrating a procedure for manufacturing the armature according to the first preferred embodiment of the present invention.

### DETAILED DESCRIPTION OF THE PREFERRED EMBODIMENTS

Hereinafter, preferred embodiments of the present invention will be described with reference to the accompanying drawings. Note that terms referring to “upward”, “downward”, “left”, “right”, etc., as used in the description of the preferred embodiments of the present invention to describe relative positions or directions of different members are simply used with reference to the accompanying drawings, and should not be construed as describing relative positions or directions of those members when actually installed in a device.

### First Preferred Embodiment

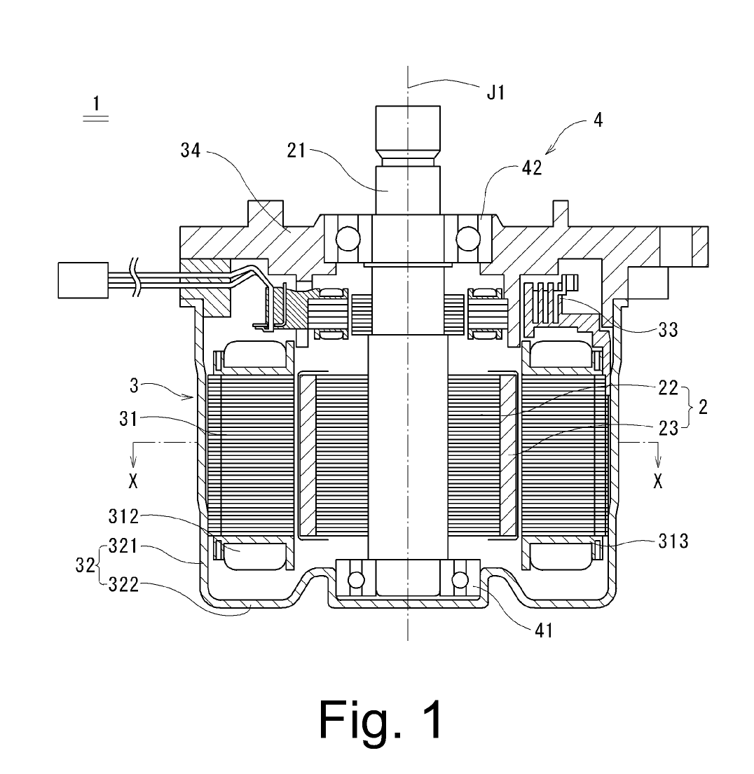

FIG. 1 is a schematic cross-sectional view of a motor 1 according to a first preferred embodiment of the present invention. As illustrated in FIG. 1, the motor 1 includes a rotating body 2, a stationary body 3, and a bearing mechanism 4. The rotating body 2 includes a rotor magnet 23 defined by a substantially annular permanent magnet centered on a central axis J1. The stationary body 3 includes an armature 31 arranged radially opposite the rotor magnet 23. The bearing mechanism 4 is arranged to support the rotating body 2 such that the rotating body 2 is rotatable about the central axis J1 with respect to the stationary body 3. The motor 1 according to the present preferred embodiment is preferably a three-phase brushless motor, but any other desired type of motor could be used. In addition, the motor 1 according to the present preferred embodiment is installed in an electric power steering apparatus. Provision of a small-sized electric power steering apparatus which produces a reduced cogging torque is thus achieved.

The rotating body 2 preferably includes a shaft 21, a rotor core 22, and the rotor magnet 23. The shaft 21 is substantially in the shape of a column, and arranged coaxially or substantially coaxially with the central axis J1. The rotor core 22 is fixed to an outer circumferential surface of the shaft 21. The rotor core 22 is preferably formed by placing a plurality of plate-shaped magnetic steel sheets one upon another in an axial direction, however any other method for forming a rotor core could be used. The rotor magnet 23 is preferably fixed to an outer circumferential surface of the rotor core 22.

A rare-earth magnet is preferably used as the permanent magnet for the rotor magnet 23. In the present preferred embodiment, in particular, a neodymium magnet whose main components are neodymium, iron, and boron is preferably used, for example. Use of the neodymium magnet as the rotor magnet 23 contributes to a considerable increase in magnetic force per unit volume, as compared to a ferrite magnet as was used in past practice. This makes it possible to provide a small-sized and high-power motor. The outside diameter of the rotor magnet 23 is preferably substantially constant along an entire circumference thereof.

The stationary body 3 preferably includes the armature 31, a housing 32, a busbar unit 33, and a bracket 34. The armature 31 is preferably arranged radially opposite to an outer circumferential surface of the rotor magnet 23. The housing 32 preferably includes a cylindrical portion 321 arranged to hold the armature 31, and a bottom portion 322 arranged axially below the armature 31 and the rotor core 22 to cover them from below. The busbar unit 33 is arranged to electrically connect the armature 31 and a control apparatus (not shown) to each other. The bracket 34 is preferably arranged axially above the armature 31, the rotor core 22, and the busbar unit 33 to cover them from above.

The bearing mechanism 4 preferably includes two ball bearings 41 and 42, which are axially spaced from each other. The ball bearing 41 is fixed to the bottom portion 322 of the housing 32. The ball bearing 42 is fixed to the bracket 34. In addition, both of the ball bearings 41 and 42 are fixed to the shaft 21 to support the rotating body 2 such that the rotating body 2 is rotatable about the central axis J1 with respect to the stationary body 3.

Regarding the motor 1 according to the present preferred embodiment, when the motor 1 is in constant-speed operation, an electromotive force which is, primarily, substantially in a sine wave form is generated in a conductor wire defining coils 312, as described below. The electromotive force generated in the conductor wire contains fifth and seventh harmonics. Here, in the motor 1 according to the present preferred embodiment, in particular, the fifth and seventh harmonics contained in the electromotive force are preferably about 3% or less and about 2% or less, respectively, of a fundamental of the electromotive force. Specifically, a predetermined degree of skew magnetization is applied to the rotor magnet 23 to achieve this specific result. This allows an electromotive force waveform to be substantially in the form of a sine wave. This contributes to easily reducing a torque ripple, as a waveform of a current supplied to the conductor wire is a sine wave.

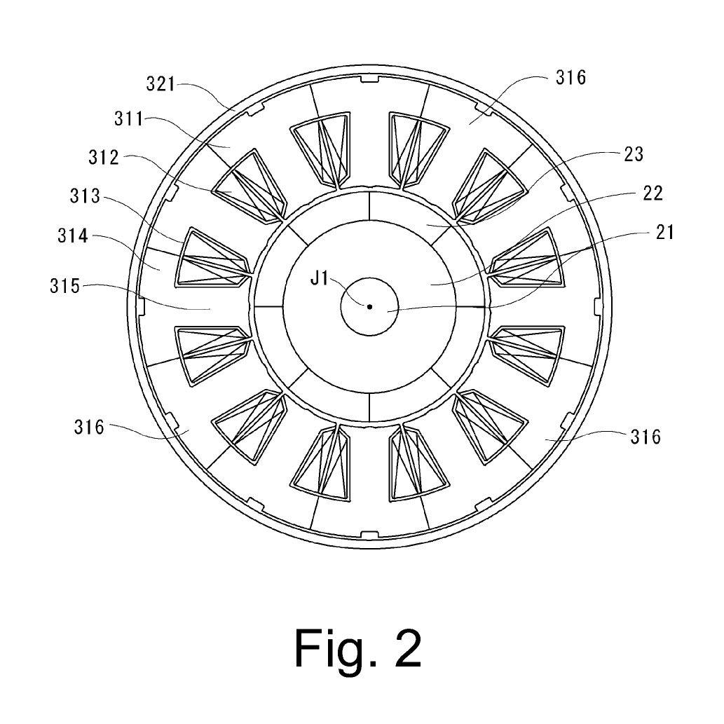

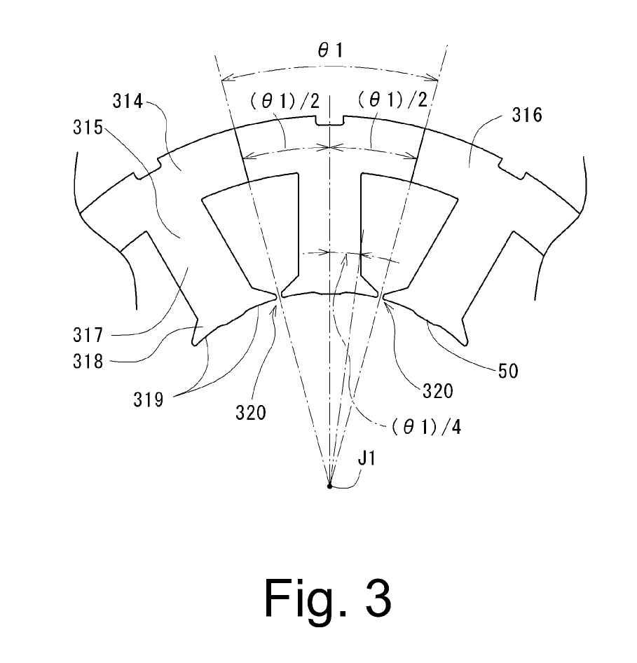

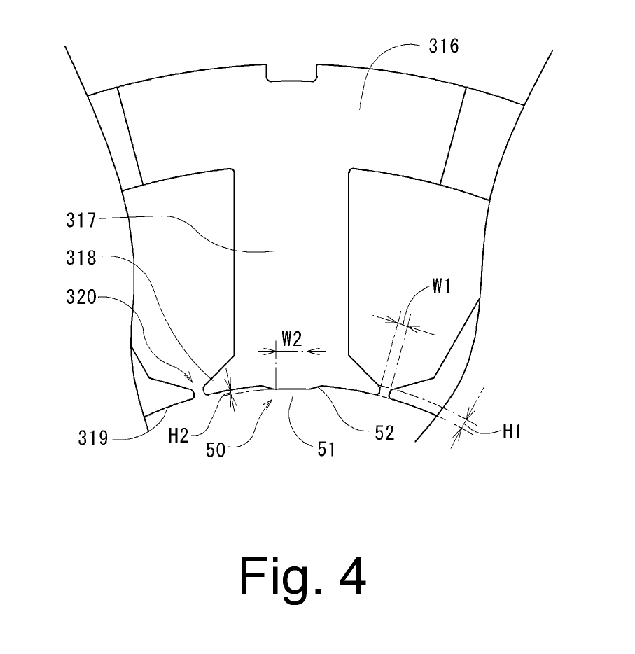

Referring to FIGS. 1 to 4, the structure of the armature 31 according to the present preferred embodiment will now be described below. FIG. 2 is a schematic cross-sectional view of the armature 31. FIG. 3 is a schematic enlarged view of a portion of an armature core 311. FIG. 4 is a schematic enlarged view of a portion of the armature core 311 illustrated in FIG. 3.

As illustrated in FIGS. 1 and 2, the armature 31 preferably includes the armature core 311, the coils 312, and an insulator 313. The armature core 311 is preferably formed by placing a plurality of magnetic steel sheets one upon another in the axial direction, but any other preferred method for making a stator core could be used. The coils 312 are preferably formed by winding the conductor wire around the armature core 311, but any other preferred method for making coils could be used. The insulator 313 is preferably made of a resin material, and arranged between the armature core 311 and the coils 312 to thereby achieve electrical insulation between the armature core 311 and the coils 312.

As illustrated in FIG. 3, the armature core 311 preferably includes a core back portion 314 and tooth portions 315, which are integral with each other. The core back portion 314 is preferably substantially annular in shape and centered on the central axis J1. Each tooth portion 315 is arranged to extend from the core back portion 314 toward the central axis J1. The armature core 311 is formed by placing a plurality of core plates, which are obtained by subjecting a steel sheet as a magnetic base material to press working, one upon another in the axial direction. However, any other preferred method for making a stator core could be used. The armature core 311 is defined by arranging a plurality of split elements 316 in a substantially annular shape. Each split element 316 includes a portion of the core back portion 314 and one of the tooth portions 315.

The coils 312 are preferably formed by so-called concentrated winding, that is, by winding the conductor wire around each tooth portion 315. The insulator 313 is arranged to cover a portion of each tooth portion 315 around which the conductor wire is wound. Moreover, the insulator 313 is arranged to cover a portion of an inner circumferential surface of the core back portion 314.

Each coil 312 is wound on the tooth portion 315 of a separate one of the split elements 316 with the insulator 313 arranged therebetween. Then, the armature 31 is formed by arranging the plurality of split elements 316, each with the coil 312 provided thereon, in a substantially annular shape.

As illustrated in FIGS. 3 and 4, the plurality of tooth portions 315 are arranged so as to be spaced from one another at regular intervals in a circumferential direction. In the present preferred embodiment, the tooth portions 315 are preferably twelve in number as illustrated in FIG. 2.

Each tooth portion 315 includes a base portion 317 and an increased width portion 318. The base portion 317 is arranged to extend from the core back portion 314 toward the central axis J1. The increased width portion 318 is arranged closer to the central axis J1 than is the base portion 317, and is greater in circumferential width than the base portion 317. Note that the circumferential width of the base portion 317 is substantially constant along a radial direction. The base portion 317 and the increased width portion 318 are integral with each other. The increased width portion 318 is arranged to increase in circumferential width with decreasing distance from the central axis J1 to a height H1 of the increased width portion 318. In addition, the increased width portion 318 has an opposed surface 319 arranged radially opposite to the rotor magnet 23. The radial distance between the opposed surface 319 and the outer circumferential surface of the rotor magnet 23 is constant along the circumferential extent of the opposed surface 319.

In addition, every two increased width portions 318 adjacent to each other in the circumferential direction have a slot opening 320 defined therebetween and arranged to open toward the rotor magnet 23. The circumferential width of the slot opening 320 is set to be equal to or smaller than the diameter of the conductor wire defining the coils 312. In the present preferred embodiment, because the split elements 316 are arranged in a substantially annular shape after the tooth portion 315 of each split element 316 is provided with the coil 312, it is possible to make each slot opening 320 have a small circumferential width. This small circumferential width contributes to reducing a cogging torque generated by the slot openings 320.

Here, referring to FIG. 4, the circumferential width of each slot opening 320 is defined as the smallest distance between every two increased width portions 318 adjacent to each other in the circumferential direction. In the present preferred embodiment, the circumferential width W1 of the slot opening 320 preferably is about 0.6 mm, for example. A central angle θ1 defined between every two slot openings 320 adjacent to each other in the circumferential direction is defined as θ1=360/N (degrees), where N is the number of tooth portions 315. In the present preferred embodiment, the pitch angle θ1 is 30 degrees because the number of tooth portions 315 is twelve. Hereinafter, the central angle θ1 defined between every two slot openings 320 adjacent to each other in the circumferential direction will be referred to as the pitch angle θ1. In addition, the circumferential width in the pitch angle θ1 is defined as one pitch.

The opposed surface 319 has, at a substantial middle thereof in the circumferential direction, a raised portion 50 arranged to project toward the rotor magnet 23. The raised portion 50 includes a first surface 51 and two inclined surfaces 52. The first surface 51 is arranged close to the rotor magnet 23. Each inclined surface 52 is arranged to join the first surface 51 and the opposed surface 319 to each other. Here, the two inclined surfaces 52, the first surface 51, and the opposed surface 319 are joined to one another through smooth curved surfaces. In addition, the two inclined surfaces 52 are inclined such that the circumferential distance therebetween increases with increasing radial distance from the central axis J1. The raised portion 50 is arranged to extend throughout the tooth portion along the central axis J1.

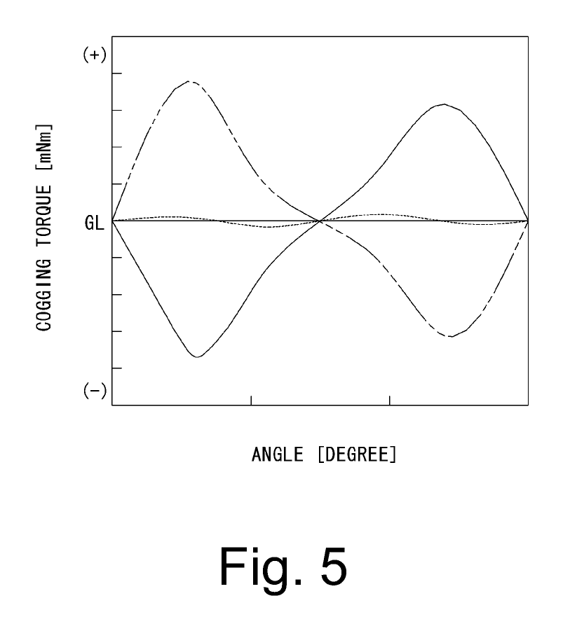

Next, a principle of a reduction of the cogging torque will now be described below with reference to FIG. 5. FIG. 5 is a graph showing a relationship between an angle and cogging torques. In FIG. 5, a chain double-dashed line represents a waveform of a cogging torque generated by the raised portions 50, a solid line represents a waveform of a cogging torque generated by tooth portions each without a raised portion (that is, a waveform of a cogging torque generated by the slot openings 320), and a broken line represents a waveform of a cogging torque generated by the tooth portions 315 each provided with the raised portion 50. Note here that the tooth portions each without a raised portion and an accompanying core back portion are assumed to be identical in shape to the tooth portions 315 and the core back portion 314, respectively, according to the present preferred embodiment, except that the former tooth portions are not provided with a raised portion.

In the armature 31, in which the number of tooth portions 315 is twelve, the raised portion 50 is provided at the substantial middle in the circumferential direction of each opposed surface 319, so that the waveform of the cogging torque generated by the raised portions 50 and a fundamental of the waveform of the cogging torque generated by the slot openings 320 will be in substantially opposite phases.

Therefore, superimposition of the waveform of the cogging torque generated by the slot openings 320 and the waveform of the cogging torque generated by the raised portions 50 upon each other results in a considerable reduction in the cogging torque generated by the tooth portions 315, each provided with the raised portion 50, because the two waveforms cancel each other out. Here, the wording “the fundamental of the waveform of the cogging torque generated by the slot openings and the waveform of the cogging torque generated by the raised portions are in opposite phases” refers to a relationship between the waveform of the cogging torque generated by the slot openings and the waveform of the cogging torque generated by the raised portions where the two waveforms are substantially symmetric with respect to a reference line GL. This relationship means that, when the amplitude of the waveform of the cogging torque generated by the slot openings is at its maximum on a positive side in FIG. 5, the amplitude of the waveform of the cogging torque generated by the raised portions is at its maximum on a negative side in FIG. 5, and that, when the amplitude of the waveform of the cogging torque generated by the slot openings is at its maximum on the negative side in FIG. 5, the amplitude of the waveform of the cogging torque generated by the raised portions is at its maximum on the positive side in FIG. 5.

Referring to FIG. 5, note in particular that the waveform of the cogging torque generated by the slot openings 320 has different maximum amplitude values between the positive and negative sides, relative to the reference line GL. Therefore, if the waveform of the cogging torque generated by the raised portions 50 is opposite in phase to the fundamental of the waveform of the cogging torque generated by the slot openings 320, the maximum amplitude values, relative to the reference line GL, of the waveforms of the cogging torques generated by the raised portions 50 and the slot openings 320, respectively, will be essentially equal with respect to the angle. Therefore, the waveform of the cogging torque generated by the raised portions 50 is able to efficiently cancel out the waveform of the cogging torque generated by the slot openings 320.

The width W2 of each raised portion 50 is preferably greater than the width W1 of each slot opening 320, and equal to or less than about half a pitch (hereinafter referred to as ½ pitch). That is, the raised portion 50 is preferably arranged not to extend over more than ¼ pitch on either circumferential side relative to the middle thereof. In the present preferred embodiment, the raised portion 50 is shaped symmetrically about the ½ pitch position.

A reduction in the height H2 of the raised portion 50 is made possible by making the width W2 of the raised portion 50 greater than the width W1 of the slot opening 320. This makes it possible to reduce a radial gap between the rotor magnet 23 and the opposed surfaces 319 of the tooth portions 315. Provision of a high-efficiency motor is thereby made possible. Due to the width W2 of each raised portion 50 being equal to or less than ½ pitch, the waveform of the cogging torque generated by the raised portions 50 and the waveform of the cogging torque generated by the slot openings 320 are in substantially opposite phases. That is, if each raised portion 50 is arranged to extend over more than ¼ pitch on either circumferential side relative to the middle of the raised portion 50, the waveform of the cogging torque generated by the raised portions 50 and the waveform of the cogging torque generated by the slot openings 320 will not be in opposite phases. Therefore, each raised portion is arranged to extend over ¼ pitch or less on both circumferential sides relative to the middle of the raised portion 50, and this allows the waveform of the cogging torque generated by the raised portions 50 and that of the cogging torque generated by the slot openings 320 to be in substantially opposite phases. As a result, the raised portions 50 are capable of efficiently canceling out the cogging torque generated by the slot openings 320. That is, provision of a high-efficiency motor which achieves an efficient reduction in the cogging torque generated therein is made possible by making the width W2 of each raised portion 50 greater than the width W1 of each slot opening 320 and equal to or less than ½ pitch.

### Second Preferred Embodiment

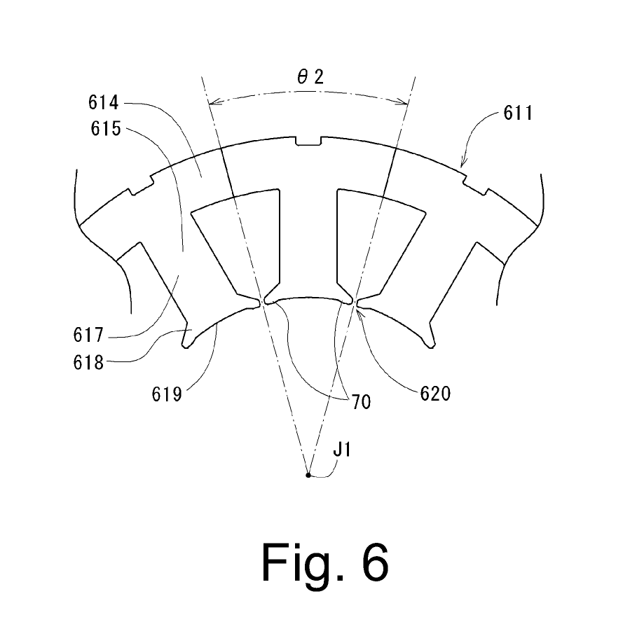

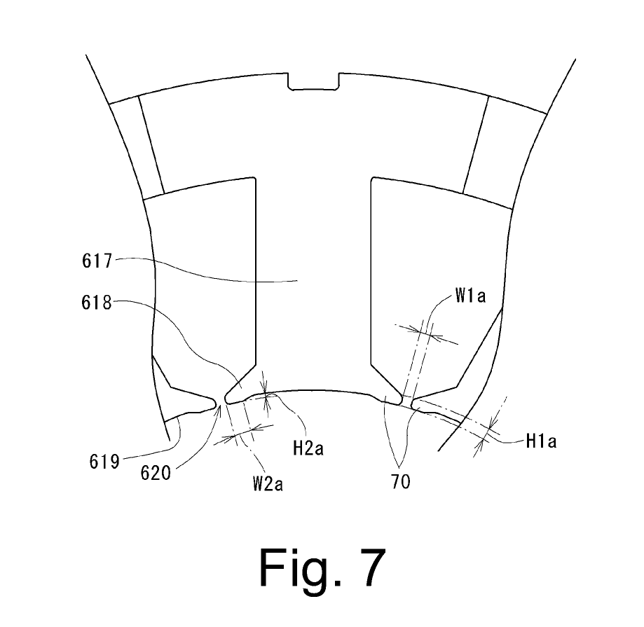

A second preferred embodiment of the present invention will now be described below with reference to FIGS. 6 and 7. FIG. 6 is a schematic enlarged view of a portion of an armature core 611. FIG. 7 is a schematic enlarged view of a portion of the armature core 611 illustrated in FIG. 6. An insulator and coils according to the present preferred embodiment are similar to those of the armature 31 according to the first preferred embodiment, and descriptions thereof will therefore be omitted. Moreover, a material of the armature core 611, the measurements thereof, the number of core plates placed one upon another, and so on are also similar to those of the armature core 311 according to the first preferred embodiment.

As illustrated in FIG. 6, the armature core 611 preferably includes a core back portion 614 and tooth portions 615, which are integral with each other. The core back portion 614 is preferably substantially annular in shape and centered on the central axis J1. Each tooth portion 615 is arranged to extend from the core back portion 614 toward the central axis J1. In the present preferred embodiment, the number of tooth portions 615 is preferably twelve, as is the case with the armature core 311.

Each tooth portion 615 includes a base portion 617 and an increased width portion 618. The base portion 617 is arranged to extend from the core back portion 614 toward the central axis J1. The increased width portion 618 is arranged closer to the central axis J1 than is the base portion 617, and is greater in circumferential width than the base portion 617. Note that the circumferential width of the base portion 617 is substantially constant along the radial direction. The base portion 617 and the increased width portion 618 are integral with each other. The increased width portion 618 is arranged to increase in circumferential width with decreasing distance from the central axis J1 to a height H1a of the increased width portion 618. In addition, the increased width portion 618 has an opposed surface 619 arranged radially opposite the rotor magnet 23.

The opposed surface 619 of each tooth portion 615 has two raised portions 70 defined therein which are spaced from each other in the circumferential direction. In addition, every two increased width portions 618 adjacent to each other in the circumferential direction include a slot opening 620 defined therebetween and opening toward the rotor magnet 23.

Here, referring to FIG. 7, the circumferential width W1a of the slot opening 620 is defined as the smallest distance between the two increased width portions 618 adjacent to each other in the circumferential direction. In the present preferred embodiment, the circumferential width W1a of the slot opening 620 is preferably about 0.6 mm, for example. In addition, a central angle θ2 defined between every two slot openings 620 adjacent to each other in the circumferential direction is 30 degrees, because the number of tooth portions 615 is twelve. Hereinafter, the central angle θ2 defined between every two slot openings 620 adjacent to each other in the circumferential direction will be referred to as the pitch angle θ2. In addition, the circumferential width in the pitch angle θ2 is defined as one pitch.

The two raised portions 70 are arranged at both circumferential ends of each opposed surface 619. This allows a waveform of a cogging torque generated by the slot openings 620 and a waveform of a cogging torque generated by the raised portions 70 to be substantially in opposite phases.

In addition, the circumferential width W2a of each raised portion 70 and the height H2a of the raised portion 70 relative to the opposed surface 619 are set so that the waveform of the cogging torque generated by the slot openings 620 and the waveform of the cogging torque generated by the raised portions 70 will have substantially equal amplitude values. Specifically, the circumferential width W2a of each raised portion 70 is about half the circumferential width W2 of the raised portion 50. The height H2a of the raised portion 70 relative to the opposed surface 619 is substantially equal to the height H2 of the raised portion 50.

The above arrangements allow the waveform of the cogging torque generated by the slot openings 620 and the waveform of the cogging torque generated by the raised portions to have substantially equal amplitude values, so that an efficient reduction in the cogging torque generated by the slot openings 620 is achieved.

Moreover, the width W2a of each raised portion 70 is preferably greater than the width W1a of each slot opening 620, and equal to or less than about a quarter of a pitch (hereinafter referred to as ¼ pitch).

Here, a reduction in the height H2a of the raised portion 70 is made possible by making the width W2a of the raised portion 70 greater than the width W1a of the slot opening 620. This makes it possible to reduce a radial gap between the rotor magnet 23 and the opposed surfaces 619 of the tooth portions 615. Provision of a high-efficiency motor is thereby made possible. Due to the width W2a of each raised portion 70 being equal to or less than ¼ pitch, the waveform of the cogging torque generated by the raised portions 70 and the waveform of the cogging torque generated by the slot openings 620 are in substantially opposite phases. As a result, the raised portions 70 are capable of efficiently canceling out the cogging torque generated by the slot openings 620. That is, provision of a high-efficiency motor which achieves an efficient reduction in a cogging torque generated therein is made possible by making the width W2a of each raised portion 70 greater than the width W1a of each slot opening 620, and equal to or less than ¼ pitch.

Third Preferred Embodiment

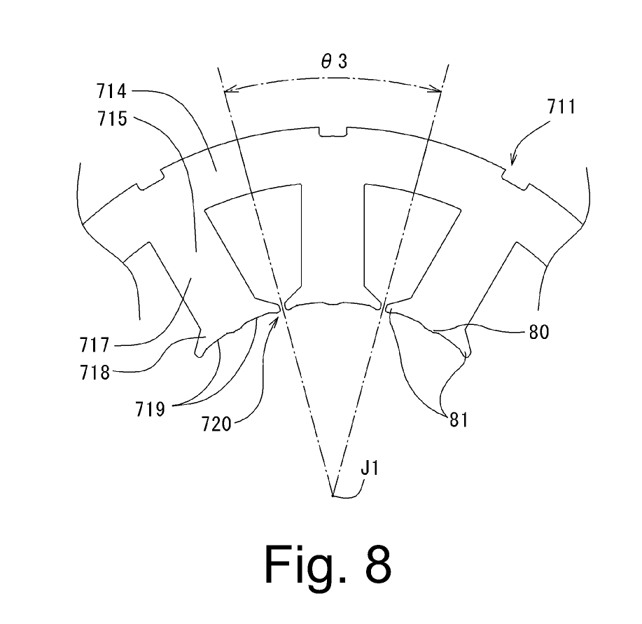

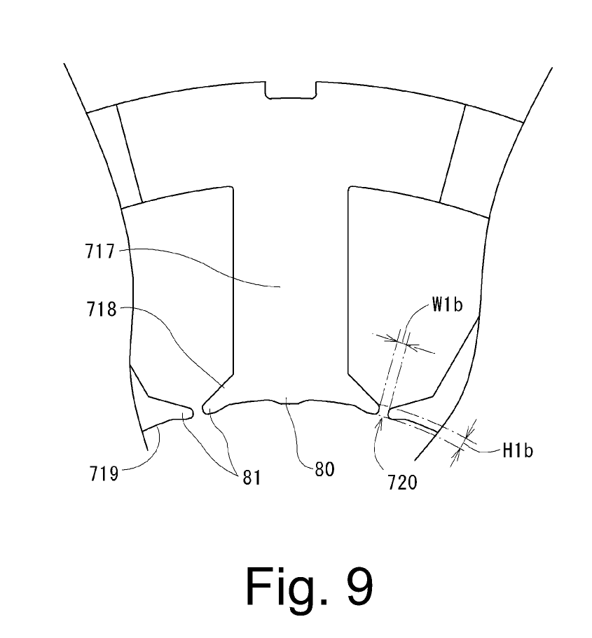

A third preferred embodiment of the present invention will now be described below with reference to FIGS. 8 and 9. FIG. 8 is a schematic enlarged view of a portion of an armature core 711. FIG. 9 is a schematic enlarged view of a portion of the armature core 711 illustrated in FIG. 8. An insulator and coils according to the present preferred embodiment are similar to those of the armature 31 according to the first preferred embodiment, and descriptions thereof will therefore be omitted. Moreover, a material of the armature core 711, the measurements thereof, the number of core plates placed one upon another, and so on are also similar to those of the armature core 311 according to the first preferred embodiment.

As illustrated in FIG. 8, the armature core 711 includes a core back portion 714 and tooth portions 715, which are integral with each other. The core back portion 714 is preferably substantially annular in shape and centered on the central axis J1. Each tooth portion 715 is arranged to extend from the core back portion 714 toward the central axis J1. In the present preferred embodiment, the number of tooth portions 715 is preferably twelve, as is the case with the armature core 311.

Each tooth portion 715 includes a base portion 717 and an increased width portion 718. The base portion 717 is arranged to extend from the core back portion 714 toward the central axis J1. The increased width portion 718 is arranged closer to the central axis J1 than is the base portion 717, and is greater in circumferential width than the base portion 717. Note that the circumferential width of the base portion 717 is substantially constant along the radial direction. The base portion 717 and the increased width portion 718 are integral with each other. The increased width portion 718 is arranged to increase in circumferential width with decreasing distance from the central axis J1. In addition, the increased width portion 718 has an opposed surface 719 arranged radially opposite to the rotor magnet 23.

The opposed surface 719 of each tooth portion 715 has defined therein a first raised portion 80 provided at a substantial middle thereof in the circumferential direction, and two second raised portions 81 provided at both circumferential ends thereof.

In addition, every two increased width portions 718 adjacent to each other in the circumferential direction include a slot opening 720 defined therebetween and opening toward the rotor magnet 23.

Here, referring to FIG. 9, the circumferential width W1b of the slot opening 720 is defined as the smallest distance between the two increased width portions 718 adjacent to each other in the circumferential direction. In the present preferred embodiment, the circumferential width W1b of the slot opening 720 is about 0.6 mm. In addition, a central angle θ3 defined between every two slot openings 720 adjacent to each other in the circumferential direction is 30 degrees, because the number of tooth portions 715 is twelve. Hereinafter, the central angle θ3 defined between every two slot openings 720 adjacent to each other in the circumferential direction will be referred to as the pitch angle θ3. In addition, the circumferential width in the pitch angle θ3 is defined as one pitch.

The above-described provision of the first raised portion 80 and the two second raised portions 81 in each opposed surface 719 allows a waveform of a cogging torque generated by the first raised portions 80, a waveform of a cogging torque generated by the second raised portions 81, and a waveform of a combination of these cogging torques superimposed upon each other to be substantially opposite in phase to a waveform of a cogging torque generated by the slot openings 720.

The circumferential width of each of the first and second raised portions 80 and 81 and the height H1b thereof relative to the opposed surface 719 are set so that the cogging torque generated by the slot openings 720 and the combined cogging torque generated by the first and second raised portions 80 and 81 will have substantially equal amplitude values.

This allows the cogging torque generated by the slot openings 720 to be cancelled out by the combined cogging torque generated by the first and second raised portions 80 and 81, so that a reduction in the cogging torque generated in the motor is achieved.

The circumferential width of each first raised portion 80 and the circumferential width of each second raised portion 81 are set within ranges of the width W2 of the raised portion 50 and the width W2a of the raised portion 70, respectively. However, each first raised portion 80 and each second raised portion 81 are arranged to have sizes smaller than the width W2 of the raised portion 50 and the width W2a of the raised portion 70, respectively.

### Fourth Preferred Embodiment

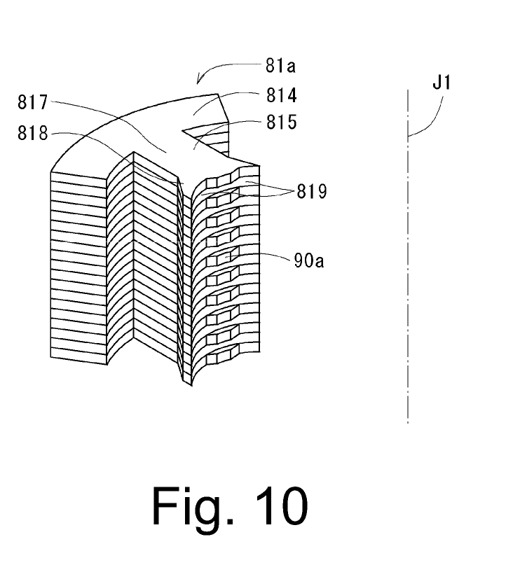

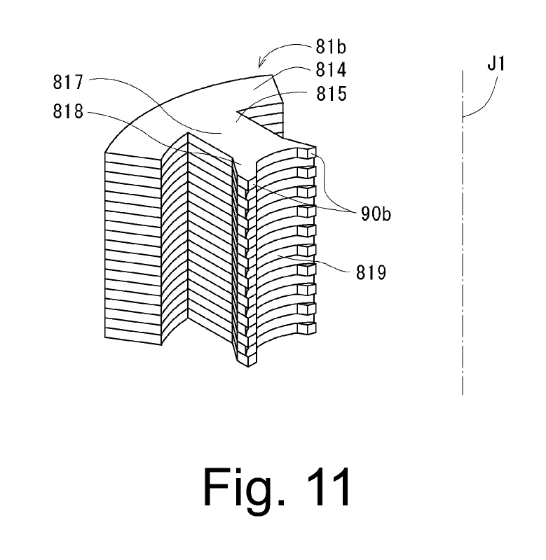

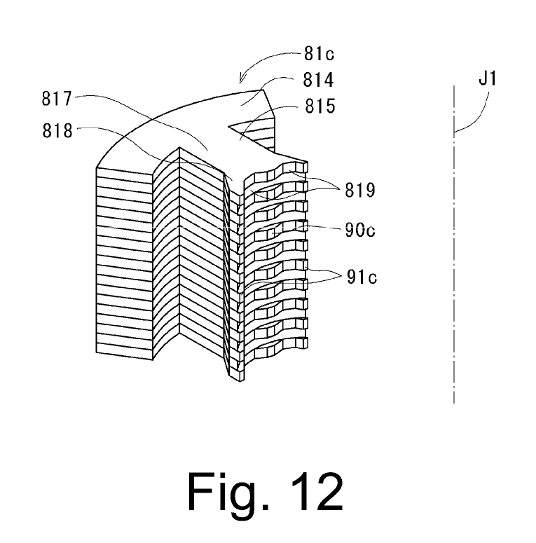

A fourth preferred embodiment of the present invention will now be described below with reference to FIGS. 10 to 12. FIG. 10 is a schematic perspective view of a portion of an armature core 81a. FIG. 11 is a schematic perspective view of a portion of an armature core 81b. FIG. 12 is a schematic perspective view of a portion of an armature core 81c. An insulator and coils that are similar to those of the armature 31 according to the first preferred embodiment will be arranged on the armature cores 81a, 81b, and 81c according to the present preferred embodiment, and descriptions thereof will therefore be omitted.

As illustrated in FIG. 10, the armature core 81a includes a core back portion 814 and tooth portions 815, which are integral with each other. The core back portion 814 is substantially annular in shape and centered on the central axis J1. Each tooth portion 815 is arranged to extend from the core back portion 814 toward the central axis J1. The tooth portion 815 includes a base portion 817 and an increased width portion 818. The base portion 817 is arranged to extend from the core back portion 814 toward the central axis J1. The increased width portion 818 is arranged closer to the central axis J1 than is the base portion 817, and is greater in circumferential width than the base portion 817. The base portion 817 and the increased width portion 818 are integral with each other. In addition, the increased width portion 818 includes an opposed surface 819 arranged radially opposite the rotor magnet 23. The opposed surface 819 includes raised portions 90a arranged at a substantial middle thereof in the circumferential direction.

As illustrated in FIG. 11, the armature core 81b is similar to the armature core 81a except in the positions, shape, and number of raised portions 90b arranged on the opposed surface 819. Unlike the raised portions 90a of the armature core 81a, the raised portions 90b of the armature core 81b are provided at both circumferential ends of the opposed surface 819.

As illustrated in FIG. 12, the armature core 81c is similar to the armature core 81a except in the shape and number of raised portions 90c and 91c arranged on the opposed surface 819. Unlike the raised portions 90a of the armature core 81a, the opposed surface 819 of the armature core 81c includes the first and second raised portions 90c and 91c arranged at a substantial middle thereof in the circumferential direction and at both circumferential ends thereof, respectively.

Here, each of the armature cores 81a, 81b, and 81c is preferably formed by placing two types of core plates, i.e., core plates provided with the raised portions and core plates without a raised portion, one upon another in the axial direction, however any other desirably armature core forming method could be used to provide the armature cores 81a, 81b, and 81c. In the preferable forming method of the present preferred embodiment as illustrated in FIGS. 10 to 12, these two types of core plates are alternately placed one upon another. Both of these two types of core plates can be obtained by subjecting steel sheets as the same base material to press working. Therefore, a change of punches of a press work machine (not shown) suffices for the operation, without the need to change the steel sheets as the base material depending on the type of the core plates. This leads to an improved efficiency in manufacturing the armature cores.

In the case where, in FIG. 10, each raised portion 90a has a width and a height equivalent to the width W2 and the height H2, respectively, of the raised portion 50 of the armature 31, an amplitude of a waveform of a cogging torque generated by the raised portions 90a will be about half an amplitude of a waveform of a cogging torque generated by the raised portions when all the core plates are provided with the raised portions. Therefore, the circumferential width of each raised portion 90a and the height thereof relative to the opposed surface 819 are set so that the amplitude of the waveform of the cogging torque generated by the raised portions 90a will be substantially equivalent to the amplitude of the waveform of the cogging torque generated by the raised portions when all the core plates are provided with the raised portions. As a result, at least one of the circumferential width of the raised portion 90a and the height thereof relative to the opposed surface 819 is arranged to be greater than the circumferential width and the height, respectively, of the raised portion when all the core plates are provided with the raised portions. Similarly, at least one of the circumferential width of each raised portion 90b of the armature core 81b illustrated in FIG. 11 and the height thereof relative to the opposed surface 819 is arranged to be greater than the circumferential width W2a of the raised portion 70 of the armature core 611 and the height H2a thereof relative to the opposed surface, respectively. Furthermore, at least one of the circumferential width and the height, relative to the opposed surface 819, of the first and second raised portions 90c and 91c of the armature core 81c illustrated in FIG. 12 is arranged to be greater than the circumferential width and the height, relative to the opposed surface, of the first and second raised portions 80 and 81 of the armature core 711, respectively.

### <Preferred Method of Manufacturing Armature>

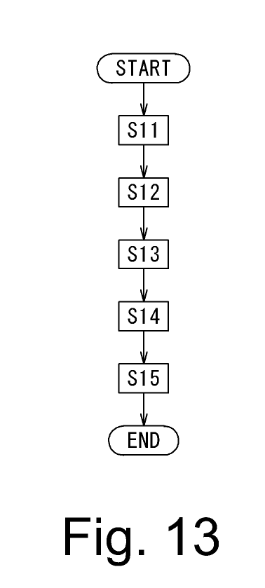

Next, a preferred method of manufacturing the armature 31 will now be described below with reference to FIG. 13. FIG. 13 is a flow chart illustrating a preferred procedure for manufacturing the armature 31.

First, the circumferential position of each of the raised portions 50 is determined so that the waveform of the cogging torque thereby will be substantially opposite in phase to the fundamental of the waveform of the cogging torque generated by the slot openings 320 of the armature 31 (step S11).

Next, the circumferential width W2 of each raised portion 50 and the height H2 thereof relative to the opposed surface 319 are determined so that the waveform of the cogging torque generated by the raised portions 50 and the waveform of the cogging torque generated by the slot openings 320 will have substantially equal amplitude values (step S12). Here, simulations may be carried out with values of the circumferential width W2 and the height H2 as parameters to determine them so that a waveform of a cogging torque obtained by superimposing the waveform of the cogging torque generated by the raised portions 50 and the waveform of the cogging torque generated by the slot openings 320 upon each other will have minimum amplitude values. That is, simulations may be carried out with the values of the circumferential width W2 and the height H2 of the raised portion 50 as parameters to determine them so that the armature core 311 will produce a minimum cogging torque.

Next, the steel sheet as the base material is subjected to press working to form the armature core 311 (step S13).

Next, the insulator 313 is attached to the armature core 311 to achieve electrical insulation between the armature core 311 and the coils 312 (step S14). The insulator 313 is actually defined by two sections divided in the axial direction, and these two sections are attached to the armature core 311 one from above and the other from below in the axial direction.

Next, the conductor wire is wound around the base portion 317 of each tooth portion 315 to form the coils 312 (step S15). The armature 31 is thereby completed.

While preferred embodiments of the present invention have been described above, the present invention is not limited to the above-described preferred embodiments, but a variety of modifications are possible.

While the number of tooth portions 315 preferably is twelve in the armature 31 according to the first preferred embodiment of the present invention, this is not essential to the present invention. In the case of three-phase brushless motors, the number of tooth portions may be any multiple of three. Also, while the rotor magnet 23 according to the first preferred embodiment of the present invention has eight poles, this is not essential to the present invention. The number of poles of the rotor magnet may be any multiple of two. Also, while an annular permanent magnet is included in the motor 1 according to the above-described preferred embodiments of the present invention, is not essential to the present invention. For example, a plurality of segmented magnets could instead be applied in place of the annular rotor magnet 23.

Also, while, in the armatures according to the above-described preferred embodiments of the present invention, the raised portions are provided at the substantial middle in the circumferential direction of the opposed surface of each tooth portion, at both circumferential ends of each opposed surface, or at the substantial middle in the circumferential direction of each opposed surface and at both circumferential ends thereof, this is not essential to the present invention. It is enough that the circumferential position of each raised portion should be so arranged that the waveform of the cogging torque generated by the raised portions and the waveform of the cogging torque generated by the slot openings will be in substantially opposite phases. Use of the raised portions provided in the armature according to any of the above-described preferred embodiments is limited to cases where either one of the following relationships is satisfied: M:N=2:(2n+1) (where n is a non-negative integer) and M:N=4:(2n+1) (where n is a non-negative integer), where M is the number of magnetic poles of the rotor magnet 23 and N is the number of tooth portions.

Also, in the case where the relationship, M:N=4:(2n+1) (where n is a non-negative integer), is satisfied, the raised portions may be provided at about ¼ pitch position or positions on the opposed surface of each tooth portion. Note here that the number of raised portions provided thereon may be either one or more. In addition, the circumferential width of each raised portion is preferably greater than the circumferential width of the slot opening, and equal to or less than about ¼ pitch. This relationship makes it possible to limit the height of the raised portion relative to the opposed surface, while achieving efficient canceling out of the cogging torque generated by the slot openings. Provision of a high-efficiency motor which achieves a reduction in the cogging torque is thus made possible.

Also, while the circumferential positions of the raised portions in the armature according to each of the above-described preferred embodiments are arranged such that the waveform of the cogging torque generated by the raised portions and the waveform of the cogging torque generated by the slot openings will be in opposite phases, the two waveforms may not necessarily be in exactly opposite phases. The circumferential positions of the raised portions may be arranged flexibly as long as the waveform of the cogging torque generated by the slot openings and the waveform of the cogging torque generated by the raised portions will cancel each other out sufficiently to produce an effect of a considerable reduction of the cogging torque in the motor.

Also, while the circumferential width and the height, relative to the opposed surface, of each raised portion of the armature according to each of the above-described preferred embodiments are so arranged that the waveform of the cogging torque generated by the raised portions and the waveform of the cogging torque generated by the slot openings will have equal amplitude values, the amplitude values may not necessarily be exactly equal. The waveform of the cogging torque generated by the slot openings and the waveform of the cogging torque generated by the raised portions may have different amplitude values as long as the waveform of the cogging torque generated by the slot openings and the waveform of the cogging torque generated by the raised portions cancel each other out sufficiently to produce the effect of a considerable reduction of the cogging torque in the motor.

Also, while the armature core according to each of the above-described preferred embodiments is preferably formed by arranging the plurality of split elements, in each of which the tooth portion is integral with the core back portion, in a substantially annular shape, this is not essential to the present invention. For example, the armature core of the armature may be formed by preparing split elements connected together in a straight line and bending them into a substantially annular shape. Also, the split elements may be defined by a substantially annular core back portion and a plurality of tooth portions separate from the core back portion.

Also, while the coils 312 according to each of the above-described preferred embodiments are formed by the concentrated winding, this is not essential to the present invention. For example, so-called distributed winding, in which each conductor wire is wound about two or more tooth portions, may also be adopted if so desired.

Also, motors according to preferred embodiments of the present invention are not limited to brushless motors, but may be motors having a plurality of brushes. Also, while the armature is included in the stationary body 3 in each of the above-described preferred embodiments of the present invention, the armature core as a portion of the armature may be included in the rotating body. In this case, the rotor magnet 23 as a permanent magnet is included in the stationary body.

Also, while the motor 1 according to each of the above-described preferred embodiments of the present invention is a so-called inner-rotor motor, in which the rotor magnet 23 is arranged radially inward of the armature 31 to cause the rotating body 2 to rotate about the central axis J1, this is not essential to the present invention. The present invention is also applicable to, for example, a so-called outer-rotor motor, in which the rotor magnet 23 is arranged radially outward of the armature 31.

Also, while those core plates which are provided with the raised portions and those core plates which are not provided with a raised portion are alternately placed one upon another to form the armature core 81a in the fourth preferred embodiment of the present invention, this is not essential to the present invention. A plurality of core plates provided with the raised portions may be placed one upon another continuously. Also, a core plate provided with the raised portion(s) may not necessarily be provided at an axial end surface of the armature core. A plurality of core plates provided with the raised portions may be placed one upon another in an axially middle portion of the armature core. The above is also true with the armature cores 81b and 81c.

Also, while, in the motor 1 according to each of the above-described preferred embodiments of the present invention, skew magnetization is applied to the rotor magnet 23 to allow the electromotive force waveform to be substantially a sine wave, this is not essential to the present invention. For example, the opposed surface of each tooth portion of the armature may be skewed to allow the electromotive force waveform to be substantially a sine wave.

Also, for example, while the method of manufacturing the armature described hereinabove is the method of manufacturing the armature according to the first preferred embodiment of the present invention, this is not essential to the present invention. For example, the method of manufacturing the armature according to the first preferred embodiment is also applicable in a similar manner to the armature according to any of the second to fourth preferred embodiments.

Also, while the motor 1 according to each of the above-described preferred embodiments of the present invention is a motor installed in an electric power steering apparatus, this is not essential to the present invention. The present invention may be applied, for example, to motors installed in devices of which a low-vibration operation is required, such as industrial machines, office machines, and so on.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-17. (canceled)

18. A motor comprising:
a permanent magnet including M magnetic poles arranged around a predetermined central axis, where M is a non-negative integer; and
an armature including N tooth portions arranged opposite to the permanent magnet with a gap therebetween, where N is a non-negative integer; wherein
the armature includes coils defined by a conductor wire wound around the tooth portions;
each of the tooth portions including an opposed surface arranged opposite the permanent magnet, the opposed surface including at least one raised portion arranged to project toward the permanent magnet;
every two tooth portions adjacent to each other in a circumferential direction about the central axis include a slot opening defined therebetween, the slot opening being arranged to open toward the permanent magnet; and
a circumferential position of each of the at least one raised portion is arranged such that a waveform of a cogging torque generated by the at least one raised portion and a fundamental of a waveform of a cogging torque generated by the slot openings are in substantially opposite phases.

19. The motor according to claim 18, wherein a circumferential width of each of the at least one raised portion and a height thereof relative to the opposed surface are arranged such that the waveform of the cogging torque generated by the slot openings and the waveform of the cogging torque generated by the at least one raised portion have substantially equal amplitude values.

20. The motor according to claim 18, wherein
a number of magnetic poles of the permanent magnet and a number of tooth portions satisfy a relationship M:N=2:(2n+1), where n is a non-negative integer; and
each of the at least one raised portion is provided at a substantial middle of the opposed surface in the circumferential direction.

21. The motor according to claim 18, wherein
a number of magnetic poles of the permanent magnet and a number of tooth portions satisfy a relationship M:N=2:(2n+1), where n is a non-negative integer; and
the at least one raised portion is provided at both circumferential ends of each opposed surface.

22. The motor according to claim 18, wherein
a number of magnetic poles of the permanent magnet and a number of tooth portions satisfy a relationship M:N=2:(2n+1), where n is a non-negative integer; and
the at least one raised portion includes first raised portions provided at a substantial middle of each opposed surface in the circumferential direction, and second raised portions provided at both circumferential ends of each opposed surface.

23. The motor according to claim 18, wherein
a number of magnetic poles of the permanent magnet and a number of tooth portions satisfy a relationship M:N=4:(2n+1), where n is a non-negative integer; and
when a circumferential distance between every two slot openings adjacent to each other in the circumferential direction is defined as one pitch, the at least one raised portion is provided at one or more positions on the opposed surface of each of the tooth portions that are about ¼ pitch away from the slot openings.

24. The motor according to claim 18, wherein a circumferential width of each of the at least one raised portion is greater than a circumferential width of each slot opening.

25. The motor according to claim 20, wherein, when a circumferential distance between every two slot openings adjacent to each other in the circumferential direction is defined as one pitch, a circumferential width of each of the at least one raised portion is greater than a circumferential width of each slot opening, and equal to or less than about ½ pitch.

26. The motor according to claim 21, wherein, when a circumferential distance between every two slot openings adjacent to each other in the circumferential direction is defined as one pitch, the circumferential width of each of the at least one raised portion is greater than a circumferential width of each slot opening, and equal to or less than about ¼ pitch.

27. The motor according to claim 22, wherein, when a circumferential distance between every two slot openings adjacent to each other in the circumferential direction is defined as one pitch,
a circumferential width of each first raised portion is greater than a circumferential width of each slot opening, and equal to or less than about ½ pitch; and
a circumferential width of each second raised portion is greater than the circumferential width of each slot opening, and equal to or less than about ¼ pitch.

28. The motor according to claim 23, wherein, when the circumferential distance between every two slot openings adjacent to each other in the circumferential direction is defined as one pitch, the circumferential width of each at least one raised portion is greater than a circumferential width of each slot opening, and equal to or less than about ¼ pitch.

29. The motor according to claim 18, wherein an axial dimension of each at least one raised portion is different from an axial dimension of each tooth portion.

30. The motor according to claim 18, wherein an electromotive force generated in the conductor wire when the motor is in constant-speed operation is substantially in the form of a sine wave.

31. The motor according to claim 30, wherein the electromotive force generated in the conductor wire includes a fifth harmonic equal to about 3% or less of a fundamental of the electromotive force, and a seventh harmonic equal to about 2% or less of the fundamental of the electromotive force.

32. The motor according to claim 31, wherein at least one of the rotor magnet and the opposed surfaces is skewed.

33. The motor according to claim 18, wherein
the armature is defined by a plurality of split elements arranged in a substantially annular shape; and
each of the plurality of split elements includes one of the tooth portions.

34. The motor according to claim 33, wherein the circumferential width of each slot opening is equal to or smaller than a diameter of the conductor wire.
